(19) United States
(12) Patent Application Publication
(10) Pub. No.: US 2007/0078807 A1
(43) Pub. Date: Apr. 5, 2007

(54) Method of building a database, system for populating a database, and method of delivering location-relevant information

(76) Inventor: David Bond, Maidenhead (GB)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/542,460

(22) Filed: Oct. 3, 2006

(30) Foreign Application Priority Data
Oct. 5, 2005 (GB) 05 20 183.5

(51) Int. Cl. G06F 17/30

(52) U.S. Cl. 707/1

(57) ABSTRACT

A method of populating a database comprises a roaming mobile terminal determining, in response to evaluation of a set of rules in relation to network data, whether global position information is required regarding the location of the mobile terminal. The network data is acquired from a communications network currently supporting the mobile terminal and globally identifies a coverage area in which the mobile terminal is located. The mobile terminal, equipped with a Global Positioning System receiver, determines the global position of the mobile terminal and communicates the global position along with the network data back to the database application for recordal as an association with the already-possessed network data.

The present invention relates to a method of building a database of the type that, for example, logs information provided by a communications terminal to a server. The present invention also relates to a system for populating a database of the type, for example, that obtains information from a communications terminal. The present invention further relates to a method of delivering location-relevant information of the type, for example, that provides a response to a request for information from a communications terminal.

### BACKGROUND ART

In the field of mobile communications, users of mobile communications terminals are known to “roam” from a so-called “home” network to a so-called “foreign” or “visited” network. The visited network need not necessarily be located in a different country to the home network; it can be a network of a partner network operator and located in the same country as the home network. Additionally, irrespective of the location on the globe of a given mobile communications terminal, it is desirable for service providers, for example providers of yellow pages services, to deliver content that is relevant to the location of the given mobile communications terminal.

However, the home network is not usually cognisant of a layout of the visited networks, and so location-based services are difficult to offer to roaming customers associated with mobile communications terminals.

Where the provision of location-based services has been attempted for roaming situations, partnerships have had to be established between the home and visited networks, additionally requiring complex interfaces between the networks.

### DISCLOSURE OF INVENTION

According to a first aspect of the present invention, there is provided a method of building a database supported by a processing resource, the method comprising the steps of: the processing resource communicating with a communications terminal, the communications terminal being located within a coverage area provided by a base station of a communications network and remote from the processing resource; the communications terminal obtaining network data from the communications network, the network data globally identifying the coverage area; the communications terminal using a location determining system independent of the communications network to determine a location of the communications terminal within the coverage area; communicating the location of the communications terminal to the processing resource; communicating the network data to the processing resource; and storing data identifying the location of the communications terminal and the network data in the database so as to provide an association between the network data and the location visited by the communications terminal.

The communications terminal may be associated with a home communications network distinct from the communications network, the home communications network also being associated with the database.

The communications terminal may evaluate at least one rule. Determination of the location of the communications terminal may be in response to a result of the evaluation of the at least one rule. The at least one rule may forbid communication of the location of the communications terminal to the processing resource. The at least one rule may be obtained from the processing resource.

The communications network may be a visited communications network.

The communications terminal may be roaming.

The communications terminal may be a mobile communications terminal.

The location determining system may be a satellite-based location determining system. The location determining system may be a global positioning system.

According to a second aspect of the present invention, there is provided a system for populating a database supported by a processing resource, the system comprising: a processing resource for supporting the database; a communications terminal located within a coverage area of a base station of a communications network and remote from the processing resource; wherein the communications terminal is arranged to obtain, when in use, network data from the communications network, the network data globally identifying the coverage area; the communications terminal is arranged to use, when in use, a location determining system independent of the communications network to determine a location of the communications terminal within the coverage area; the communications terminal is arranged to communicate, when in use, the location of the communications terminal to the processing resource; the communications terminal is arranged to communicate, when in use, the network data to the processing resource; and the database is arranged to store, when in use, in the database data identifying the location of the communications terminal and the network data so as to provide an association between the data identifying the coverage area and the location visited by the communications terminal.

According to a third aspect of the present invention, there is a provided database comprising: a plurality of network data entries respectively globally identifying coverage areas supported by base stations of a communications network; a plurality of location data entries respectively identifying geographic locations; wherein an association between a coverage area of the globally identified coverage areas and at least one geographic location of the geographic locations is recorded.

According to a fourth aspect of the present invention, there is provided a method of delivering location-relevant information via a communications terminal located within a coverage area supported by a base station of a communications network, the method comprising the steps of: the communications terminal communicating a request for information to an information delivery service; the communications terminal obtaining network data from the communications network, the network data globally identifying the coverage area; the communications terminal communicating the network data to the information delivery service; wherein the information delivery service accesses a database in order to translate the network data into a geographic location, the database comprising an association between the network data and the geographic location; the information delivery service uses the geographic location retrieved in order to obtain information responsive to the request for information communicated from the communications terminal, the response being relevant to the geographic location retrieved; and the information service delivers a response to the communications terminal.

The database may comprise data collected from a plurality of communications terminals each having a position determining capability independent of the communications network.

According to a fifth aspect of the present invention, there is provided a computer program code element comprising computer program code means to make a computer execute the method as set forth above in relation to the first and fourth aspects of the invention. The computer program code element may be embodied on a computer readable medium.

It is thus possible to provide a method of building a database and a system for populating a database that enables a global map of network cells, both national and international if desired without limitation to the operator of the communications network that can be used to provide location-relevant services to users of mobile terminals, where the users do not have geographic location determining systems at their disposal, such as Global Positional Systems. Further, maintenance of the database to ensure changes to a given foreign network are recorded automatically without requiring specific advice of the changes from an operator of the foreign network. Additionally, it is possible to deliver location-relevant information to communications terminals that one not equipped with location determining hardware/software.

### BRIEF DESCRIPTION OF DRAWINGS

At least one embodiment of the invention will now be described, by way of example only, with reference to the accompanying drawings, in which:

FIG. 1 is a schematic diagram of a communications system constituting an embodiment of the invention;

FIG. 2 is a flow diagram of a first method for use with the system of FIG. 1; and

FIG. 3 is a flow diagram of a second method for use with the system of FIG. 1.

### DETAILED DESCRIPTION

Throughout the following description identical reference numerals will be used to identify like parts.

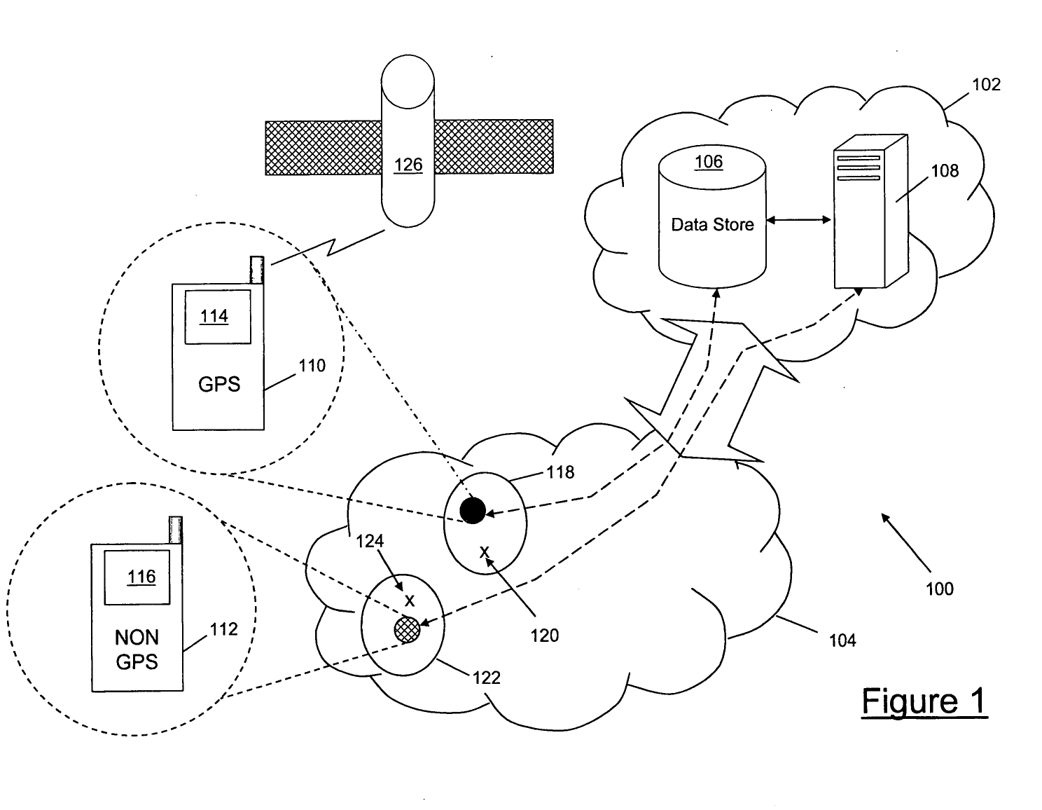

Referring to FIG. 1, a communications system 100 comprises a home communications network 102 capable of communicating with a foreign communications network 104. In this example, the home and foreign communications networks 102, 104 are Global System for Mobile communications (GSM) networks.

A database application 106 is coupled to the home communications network 102 and is capable of communication with a content delivery system supported by a service server 108 as well as with a first mobile communications terminal 110, for example a first cellular telecommunications handset. The database application 106 supports a database for storing associations between network data and data corresponding to physical locations. The database application 106 is supported by a processing resource, for example, but not limited to, a server (not shown). Further, the content delivery system 108 is capable of communication with a second mobile communications terminal 112, for example a second cellular telecommunications handset.

In this example, the first and second mobile communications terminals 110, 112 are roaming in the foreign communications network 104. The first mobile communications terminal 110 is equipped with global location determining hardware and software, for example, a Global Positioning Satellite (GPS) receiver. Consequently, the first mobile communications terminal 110 is capable of receiving signals from a number of satellites 126, for example at least three satellites, such as six satellites, for triangulation purposes. The first mobile communications terminal 110 also supports a first software agent application 114. The second mobile communications terminal 112 does not possess global location determining hardware and software, but does support a second software agent application 116.

The first mobile communications terminal 110 is located within a first coverage area of the foreign communications network 104, for example a first cell 118, supported by a first Node B 120. The second mobile communications terminal 112 is located in a second coverage area of the foreign communications network 104, for example, a second cell 122 supported by a second Node B 124.

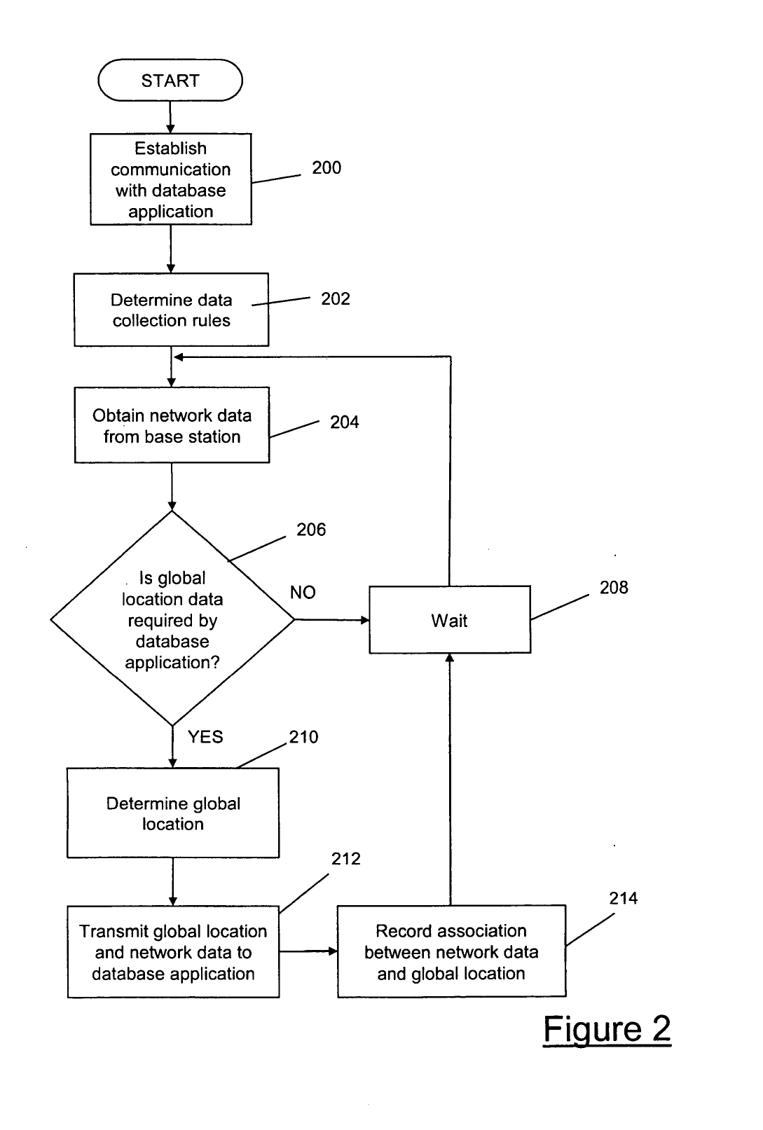

In operation (FIG. 2), in order to populate the database supported by the database application 106, the first agent 114 residing on the first mobile communications terminal 110 firstly establishes (Step 200) a communication with the database application 106 and then determines rules for making location measurements by obtaining (Step 202) the rules from the database application 106. The first mobile communications terminal 1 10 then obtains (Step 204), on behalf of the first agent 114, first network data from the first base station 120. The first network data serves to identify globally the first coverage area 118 amongst the cellular communications networks available to the first mobile terminal 110 worldwide. In this example, the first network data identifies the first coverage area 118 from amongst all the cellular communications networks in the world and so the first network data is, in this example, a Mobile Country Code (MCC), a Mobile Network Code (MNC) and a Cell ID tuple.

Once the first network data has been obtained by the first agent 114, the first agent 114 evaluates the rules acquired in relation to the first network data obtained and determines (Step 206) whether the evaluation of the rules in relation to the first network data results in a need to obtain global location data, for example, a rule to collect global location data when roaming in cells in Spain, but not France, can be implemented. The rules can also be configured by the database application 106 to reflect the fact that the database application 106 considers the database to contain sufficient global location data for the MCC:MNC:Cell ID tuple constituting the first network data provided or that the database contains insufficient global location data for the MCC:MNC:Cell ID tuple provided. Typically, the latter state prevails, since the layout of communications networks changes regularly over time. If no data is deemed by the database application to be required, the database application 106 responds negatively to the first agent 114 and the first agent 114 waits (Step 208) until the first network data changes. Thereafter, the above described steps are repeated. Although not shown in FIG. 2, the first agent 114 can be configured to refresh periodically the rules acquired.

Alternatively, the evaluation of the rules results in a determination that global location data is required for the MCC:MNC:Cell ID tuple as the first network data provided, and so the first agent 114, using the GPS receiver of the first mobile communications terminal 110, determines (Step 210) a global position of the first mobile terminal 110.

Thereafter, the first agent 114 communicates (Step 212) the global position and the first network data acquired to the database application 106, the database application 106 recording (Step 214) an association between the first network data previously provided and the global location data received.

The first agent 114 then waits (Step 208) until the first network data changes. Thereafter, the above described steps are repeated. Further, the above described steps are repeated in relation to other mobile communications terminals (not shown) that are equipped with global location determining hardware and software, and that are roaming. Of course, the skilled person will appreciate that the mobile communications terminals equipped with global location determining hardware and software need not necessarily be roaming in visited networks in other countries to the location of the database application 106, but can be roaming in other “domestic” networks in the same country as the database application 106. Indeed, the above described steps for populating the database can be employed in relation to the home network 102 as an alternative to maintaining a manually updated record of location information in relation to Cell IDs of the home network 102.

Of course, global position data collected in the database can “cluster” into groups of global positions associated with a given MCC:MNC:CellID tuple, indicating a location in the home or the visited network that attracts a number of users, for example a popular location, such as a restaurant or a football stadium.

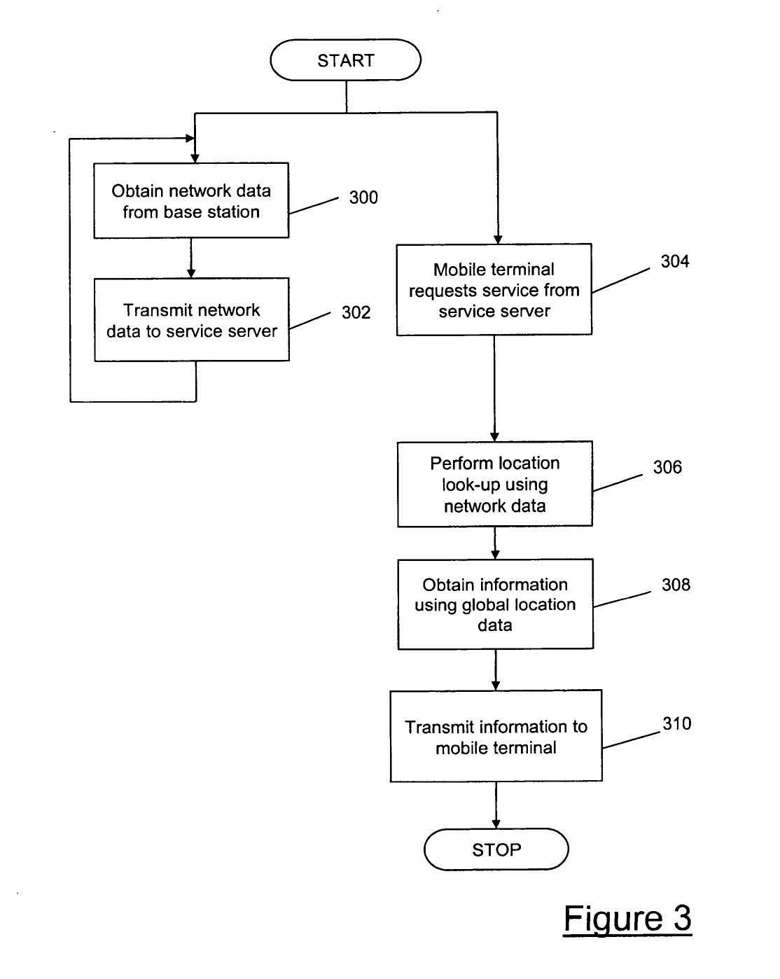

Referring to FIG. 3, the second mobile communications terminal 112 is also roaming in the foreign network 104, though without position determining capabilities as mentioned above. Further, a user (not shown) of the second mobile terminal 112 requires information that is relevant to the location of the user. In this example, the user requires a yellow pages service to identify a restaurant local to second mobile terminal 112 and to provide a telephone number of the restaurant.

Whilst the second mobile terminal is powered-up, the second agent 116 periodically obtains (Step 300) second network data from the second base station 124 and establishes (Step 302) a communication with the service server 108 and communicates the second network data to the service server 108. The second network data again serves to identify globally the second coverage area 122 amongst the cellular communications networks available to the second mobile terminal 110 worldwide. In this example, the second network data identifies the second coverage area 122 from amongst all the cellular communications networks in the world and so the second network data is a second MCC:MNC:Cell ID tuple.

Before, during, or after the above repeating procedure (Steps 300 and 302), the second mobile terminal 112 using, for example a web-browser application supported by the second mobile terminal 112, establishes a communication with the service server 108 and requests (Step 304) a telephone number for a restaurant local to the second mobile terminal 112. Of course, the skilled person will appreciate that the acquisition of the second network data can be triggered in response to the request for location-relevant information.

The service server 108 then sends a request to the database application 106 for global location data corresponding to the second network data, the second network data being contained in the request sent to the database application 106. Using the second network data received, the database application 106 accesses the database and looks-up (Step 306) global location data associated with the second network data received. If no global location data is available, the user is, in this example, prompted for more information about the location of the user, or a lower grade of location-based service is offered. For example, rather than providing the user with contact details for an hotel local to the user, the user can be provided with the contact details for a centralised “hotel hotline”. Alternatively, the visited network 104 can provide, if available, an alternative location determination service using, for example, triangulation of signals from base stations. However, if available, the global location data is then returned to the service server 108 and, using the global location data received, the service server 108 retrieves (Step 308) the restaurant information relevant to the location of the second mobile terminal 112 using any known suitable database mining technique.

In one embodiment, the clusters of location points mentioned previously above can be correlated with establishments, organisations and/or events known to the service server 108 to enable the service server 108 to deliver information of greater quality. For example, if a location of one restaurant local to the user has a greater cluster of location points than another restaurant, this would be interpreted by the service server 108 as an indication of popularity and so the restaurant having the greater cluster of location points would be selected for the user, or ranked above other restaurants (or e stablishments or events) local to a current position of the user. Thereafter, the retrieved information is delivered (Step 310) to the second mobile terminal 112 via the web-browser application.

In another embodiment, the service server 108 simply detects events relating to the location of the second mobile terminal 112, for example transitions, such as changes to the CellID and/or the MNC and/or the MCC in order to track movement of the second mobile terminal 112.

Of course, the principles of the above example are not limited to cellular communications networks and mobile communications terminals. In this respect, the principles of the above example can be applied to other environments, for example: games consoles, where the location of mobile games consoles can be a feature of a game; security systems, where stolen mobile equipment can be tracked despite crossing international borders; Digital Video Broadcasting (DVB), Digital Audio Broadcasting (DAB), Digital Video Broadcasting—Handheld (DVB-H), where digital programming broadcasts can be tailored to the location of the user; and/or emergency services, where a user making an emergency call can be tracked by a home network operator.

Although the above example has been described in the context of GSM networks, the skilled person will appreciate that the above embodiment can be employed in relation to other communications networks, for example Universal Mobile Telecommunications System (UMTS), Worldwide Interoperability for Microwave Access (WiMAX) or Wireless Fidelity (WiFi) networks.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A method of building a database supported by a processing resource, the method comprising the steps of:
the processing resource communicating with a communications terminal, the communications terminal being located within a coverage area provided by a base station of a communications network and remote from the processing resource;
the communications terminal obtaining network data from the communications network, the network data globally identifying the coverage area;
the communications terminal using a location determining system independent of the communications network to determine a location of the communications terminal within the coverage area;
communicating the location of the communications terminal to the processing resource;
communicating the network data to the processing resource; and
storing data identifying the location of the communications terminal and the network data in the database so as to provide an association between the network data and the location visited by the communications terminal.

2. A method as claimed in claim 1, wherein the communications terminal is associated with a home communications network distinct from the communications network, the home communications network also being associated with the database.

3. A method as claimed in claim 1, wherein the communications network is a visited communications network.

4. A method as claimed in claim 1, wherein the communications terminal is roaming.

5. A method as claimed in claim 1, wherein the communications terminal is a mobile communications terminal.

6. A method as claimed in claim 1, wherein the location determining system is a satellite-based location determining system.

7. A system for populating a database supported by a processing resource, the system comprising:
a processing resource for supporting the database;
a communications terminal located within a coverage area of a base station of a communications network and remote from the processing resource; wherein
the communications terminal is arranged to obtain, when in use, network data from the communications network, the network data globally identifying the coverage area;
the communications terminal is arranged to use, when in use, a location determining system independent of the communications network to determine a location of the communications terminal within the coverage area;
the communications terminal is arranged to communicate, when in use, the location of the communications terminal to the processing resource;
the communications terminal is arranged to communicate, when in use, the network data to the processing resource; and
the database is arranged to store, when in use, in the database data identifying the location of the communications terminal and the network data so as to provide an association between the data identifying the coverage area and the location visited by the communications terminal.

8. A database comprising:
a plurality of network data entries respectively globally identifying coverage areas supported by base stations of a communications network;
a plurality of location data entries respectively identifying geographic locations; wherein
an association between a coverage area of the globally identified coverage areas and at least one geographic location of the geographic locations is recorded.

9. A method of delivering location-relevant information via a communications terminal located within a coverage area supported by a base station of a communications network, the method comprising the steps of:
the communications terminal communicating a request for information to an information delivery service;
the communications terminal obtaining network data from the communications network, the network data globally identifying the coverage area;
the communications terminal communicating the network data to the information delivery service; wherein
the information delivery service accesses a database in order to translate the network data into a geographic location, the database comprising an association between the network data and the geographic location;
the information delivery service uses the geographic location retrieved in order to obtain information responsive to the request for information communicated from the communications terminal, the response being relevant to the geographic location retrieved; and
the information service delivers a response to the communications terminal.

10. A method as claimed in claim 9, wherein the database comprises data collected from a plurality of communications terminals each having a position determining capability independent of the communications network.
